(19) United States
(12) Patent Application Publication
(10) Pub. No.: US 2018/0265808 A1
(43) Pub. Date: Sep. 20, 2018

(54) CLEANING COMPOSITION AND METHOD OF FORMING THE SAME

(71) Applicant: BASF SE, Ludwigshafen am Rhein (DE)

(72) Inventor: Stephen F. GROSS, Rockwood, MI (US)

(21) Appl. No.: 15/544,065

(22) PCT Filed: Jan. 21, 2016
(86) PCT No.: PCT/US2016/014286

§ 371 Date: Jul. 17, 2017

Related U.S. Application Data
(60) Provisional application No. 62/106,000, filed on Jan. 21, 2015.

(51) Int. Cl. C11D 1/94; C11D 3/37; C11D 3/20

(52) U.S. Cl. CPC C11D 1/94; C11D 1/90; C11D 3/2086; C11D 3/3723

(57) ABSTRACT

A cleaning composition for dishwashing including an alkoxylated polyethylenimine and a surfactant actives component. The surfactant actives component includes an anionic surfactant, an additional surfactant, a betaine, and an amine oxide. A method of forming the cleaning composition is also disclosed. The method includes the step of combining the alkoxylated polyethylenimine and the surfactant actives component to form the cleaning composition.

### CROSS REFERENCE TO RELATED APPLICATIONS

This application claims priority to U.S. Provisional Patent Application No. 62/160,000, filed on Jan. 21, 2015, which is hereby incorporated by reference.

### FIELD OF THE DISCLOSURE

The present disclosure generally relates to a cleaning composition useful for dishwashing, and more specifically to a cleaning composition including an alkoxylated polyethylenimine and a surfactant actives component, and also to a method of forming the cleaning composition.

### BACKGROUND

Cleaning compositions, such as those used for manual (or hand) dishwashing, are understood in the art. Dishwashing liquids, also known as “dishwashing soaps” or “dish soaps,” are detergents used to assist in dishwashing. Such cleaning compositions are usually highly-foaming mixtures of surfactants with low skin irritation, and are primarily used for hand washing of glasses, plates, cutlery, and cooking utensils in a sink, tub, or bowl. Alcohols, along with other viscosity modifiers, such as such as glycol ethers and short chain surfactants, are typically utilized in conventional cleaning compositions to reduce the viscosity of the conventional cleaning compositions. However, due to the flammability of alcohols, a cleaning composition including alcohol is undesirable. Accordingly, there remains an opportunity to provide improved cleaning compositions for dishwashing.

### SUMMARY OF THE DISCLOSURE AND ADVANTAGES

The present disclosure provides a cleaning composition for dishwashing. The cleaning composition includes an alkoxylated polyethylenimine in an amount of from 0.01 to 20 wt. %. The cleaning composition also includes a surfactant actives component. The surfactant actives component includes an anionic surfactant in an amount of from 1 to 99 wt. %, an additional surfactant in an amount of from 0 to 99 wt. %, a betaine in an amount of from 0.1 to 7 wt. %, and an amine oxide in an amount of from 0 to 6 wt. % with the proviso that the total wt. % of the anionic surfactant, the additional surfactant, the betaine, and the amine oxide is in an amount of at least 20 wt. %. Each wt. % is based on a total weight of the cleaning composition. A method of forming the cleaning composition is also disclosed. The method includes the step of combining the alkoxylated polyethylenimine and the surfactant actives component to form the cleaning composition.

The cleaning composition may be useful for dishwashing, and tends to be especially useful for manual (or hand) dishwashing. The cleaning composition has a low viscosity without utilizing viscosity modifiers, such as alcohols, glycol ethers, and short chain surfactants. In addition, the cleaning composition tends to have excellent cleaning performance, such as increased dishwashing performance in terms of plate count (e.g. according to ASTM D4009, Method A, Soil B) without increasing surfactant actives relative to conventional cleaning compositions. Among other benefits, by not increasing surfactant actives relative to conventional cleaning, the cleaning composition typically has increased performance at equal cost, or equal performance at lower cost, relative to conventional cleaning compositions.

### DETAILED DESCRIPTION OF THE DISCLOSURE

The present disclosure provides a cleaning composition. The cleaning composition is typically useful for dishwashing, and is especially useful for manual (or hand) dishwashing. The cleaning composition is typically in the form of a liquid, and is generally high sudsing and foaming in nature, much like conventional liquid hand dishwashing detergents. The cleaning composition may be described as a light duty liquid (i.e., “LDL”) detergent.

The cleaning composition can be applied to a variety of different surfaces, and the cleaning composition is not limited to use with any particular surface. Examples of such surfaces include those found on or in cookware, bakeware, tableware, dishware, flatware, and glassware. As used herein “dishware” generally describes dishes, glasses, pots, pans, baking dishes and flatware made from ceramic, china, metal, glass, plastic (e.g. polyethylene, polypropylene, polystyrene, etc.) and wood. The cleaning composition is not limited to use with any particular soil or surface.

The cleaning composition includes an alkoxylated polyethylenimine in an amount of from 0.01 to 20 weight percent (wt. %). In certain embodiments, the cleaning composition also includes lactic acid in an amount of from 0.1 to 20 wt. %. The cleaning composition further includes a surfactant actives component. In various embodiments, the surfactant actives component includes an anionic surfactant in an amount of from 1 to 99 wt. %, an additional surfactant in an amount of from 0 to 99 wt. %, a betaine in an amount of from 0.1 to 7 wt. %, and an amine oxide in an amount of from 0 to 6 wt. % with the proviso that the total wt. % of the anionic surfactant, the additional surfactant, the betaine, and the amine oxide is in an amount of at least 20 wt. %. In other embodiments, the surfactant actives component includes the anionic surfactant with the proviso that the total wt. % of the anionic surfactant is in an amount of at least 20 wt. %. Each wt. % is based on a total weight of the cleaning composition.

In one embodiment of the cleaning composition, the cleaning composition includes an alkoxylated polyethylenimine in an amount of from 0.01 to 20 wt. %. The cleaning composition also includes a surfactant actives component. The surfactant actives component includes an anionic surfactant in an amount of from 1 to 99 wt. %, an additional surfactant in an amount of from 0 to 99 wt. %, a betaine in an amount of from 0.1 to 7 wt. %, and an amine oxide in an amount of from 0 to 6 wt. % with the proviso that the total wt. % of the anionic surfactant, the additional surfactant, the betaine, and the amine oxide is in an amount of at least 20 wt. %. Each wt. % is based on a total weight of the cleaning composition.

In another embodiment of the cleaning composition, the cleaning composition includes an alkoxylated polyethylenimine in an amount of from 0.01 to 20 wt. %. The cleaning composition also includes lactic acid in an amount of from 0.1 to 20 wt. %. The cleaning composition further includes a surfactant actives component in an amount of at least 20 wt. %. The surfactant actives component includes an anionic surfactant. Each wt. % is based on a total weight of the cleaning composition.

In further embodiments, the surfactant actives component of the cleaning composition consists essentially of an anionic surfactant in an amount of from 5 to 20 wt. %, a betaine in an amount of from 0.1 to 7 wt. %, and a nonionic surfactant in an amount of from 1 to 20 wt. % with the proviso that the total wt. % of the anionic surfactant, the betaine, and the nonionic surfactant is in an amount of at least 20 wt. %. In these further embodiments, the cleaning composition is free of an alcohol and the cleaning composition is free of an amine oxide. In one embodiment, the terminology “consists essentially of” describes that the surfactant actives component is free of other surfactant actives which may impact the cleaning performance of the cleaning composition.

The alkoxylated polyethylenimine is typically useful for reducing the viscosity of the cleaning composition, especially in embodiments wherein alcohol is minimized, or eliminated. In addition, the alkoxylated polyethylenimine is useful for increasing the cleaning performance of the cleaning composition without increasing a wt. % of surfactant actives in the cleaning composition. The surfactant actives component is typically useful for dissolving and/or emulsifying certain types of soils. The surfactant actives component is also typically useful for surface wetting which helps deliver the cleaning composition to the ware surface(s). The lactic acid is typically useful as an antibacterial active, especially in embodiments of the cleaning composition which are free of a conventional antibacterial component. The cleaning composition can also include one or more additional components (or additives) as described in greater detail below.

### Alkoxylated Polyethylenimine

Referring now to the alkoxylated polyethylenimine, the alkoxylated polyethylenimine may be described as a cleaning polymer and includes a polymer portion with repeating units including amine groups and ethylene groups. The polymer portion may be described as a polyethylenimine backbone of the alkoxylated polyethylenimine. In the alkoxylated polyethylenimine, one or more nitrogen atoms of the amine groups are typically modified with one or more alkoxy moieties to form the alkoxylated polyethylenimine. Polyethylenimines may be described as polyaziridines.

The amine groups of the polyethylenimine backbone can be primary, secondary, and/or tertiary. The polyethylenimine backbone can have a linear, branched, dendrimeric, or comb-like structure. The polyethylenimine backbone may have a weight average molecular weight of from 100 to 2,000, 200 to 1,500, 300 to 1,000, 400 to 800, or 500 to 700, g/mol. Exemplary polyethylenimine backbones include, but are not limited to:

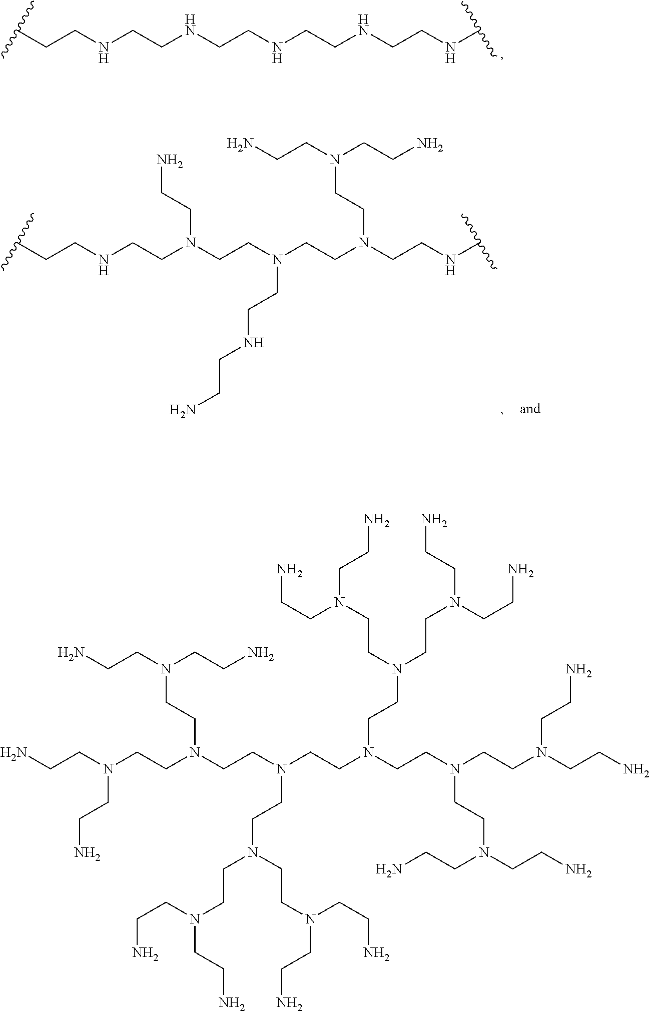 [SMILES: *CCNCCNCCNCCNCCN* ; *CCNCCN(CCN)CCN(CCNCCN)CCN(CCN*)CCN(CCN)CCN ; NCCN(CCN)CCN(CCN(CCN)CCN)CCN(CCN(CCN(CCN)CCN)CCN(CCN)CCN)CCN(CCN(CCN(CCN)CCN)CCN(CCN)CCN)CCN(CCN(CCN)CCN)CCN(CCN)CCN]

In the exemplary polyethylenimine backbone structures provided above, it is to be appreciated that one or more of the hydrogen atoms of the amine groups may be replaced with one or more alkoxy moeities.

The alkoxy moieties of the alkoxylated polyethylenimine may be ethoxy moieties, propoxy moieties, or butoxy moieties. The alkoxylated polyethylenimine may include ethoxy moieties, propoxy moieties, butoxy moieties, or a combination thereof. Thus, the alkoxylated polyethylenimine may be an ethoxylated polyethylenimine, a propoxylated polyethylenimine, a butoxylated polyethylenimine, an ethoxylated/propoxylated polyethylenimine, a propoxylated/butoxylated polyethylenimine, an ethoxylated/butoxylated polyethylenimine, or an ethoxylated/propoxylated/butoxylated polyethylenimine. In various embodiments, the alkoxylated polyethylenimine is free of propoxy moieties.

In certain embodiments the alkoxylated polyethylenimine is an ethoxylated polyethylenimine having a plurality of nitrogen atoms and has from 1 to 40, 5 to 35, 10 to 30, 15 to 25, 17 to 23, or 18 to 22, ethoxy moieties bonded to each nitrogen atom of the polyethylenimine backbone. The alkoxylated polyethylenimine may have a weight average molecular weight of from 5,000 to 20,000, 7,000 to 15,000, 8,000 to 14,000, 9,000 to 13,000, or 10,000 to 12,000, g/mol. It is to be appreciated that the weight average molecular weight of the alkoxylated polyethylenimine includes the polyethylenimine backbone and the alkoxy moieties.

In certain embodiments, the alkoxylated polyethylenimine is a branched ethoxylated polyethylenimine having 20 ethoxy moieties bonded to each nitrogen atom and having a polyethylenimine backbone having a weight average molecular weight of 600 g/mol. This branched ethoxylated polyethylenimine has a weight average molecular weight of 11,000 g/mol. One exemplary ethoxylated polyethylenimine is, but is not limited to:

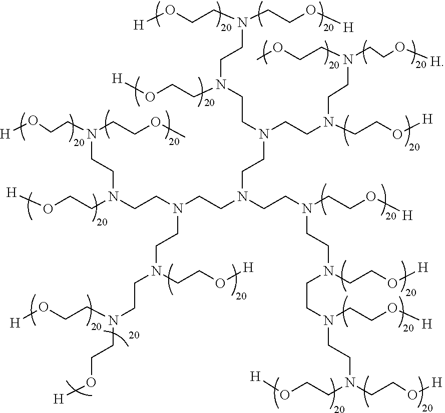

Alkoxylated polyethylenimines are typically formed from an acid-catalyzed ring opening reaction of ethylenimine (or aziridine). Commercial examples of suitable alkoxylated polyethylenimines are available from BASF Corporation of Florham Park, N.J. under the trade name Sokalan®, such as Sokalan® HP20. Other commercial examples of alkoxylated polyethylenimines which may be suitable in the cleaning composition are available from BASF Corporation of Florham Park, N.J. under the trade name Lupasol®, such as Lupasol® SC-61B.

In various embodiments, the alkoxylated polyethylenimine is present in the composition in an amount of at least 0.01, 0.05, or 0.1, or from 0.01 to 10, 0.05 to 5, 0.05 to 5, 0.1 to 2, or 0.1 to 1, wt. %, each based on a total weight of the cleaning composition, or any value or range of values therebetween. Typically, the amounts described herein are based on the assumption that the alkoxylated polyethylenimine includes 100% actives. As such, if the alkoxylated polyethylenimine is aqueous, for example, the amounts can be adjusted accordingly to compensate for % actives dilution as would be understood in the art.

In addition to the alkoxylated polyethylenimine, other polyethylenimines which may not be alkoxylated may be utilized in the cleaning composition. Commercial examples of suitable polyethylenimines are available from BASF Corporation of Florham Park, N.J. under the trade name Lupasol®, such as Lupasol® FG, Lupasol® G20, Lupasol® G20 Waterfree, Lupasol® G35, Lupasol® P, Lupasol® PR8515, Lupasol® PS, Lupasol® SK, and Lupasol® WF. In various embodiments, the polyethylenimine is present in the composition in an amount of at least 0.01, 0.05, or 0.1, or from 0.01 to 10, 0.05 to 5, 0.05 to 5, 0.1 to 2, or 0.1 to 1, wt. %, each based on a total weight of the cleaning composition, or any value or range of values therebetween. Typically, the amounts described herein are based on the assumption that the polyethylenimine includes 100% actives. As such, if the polyethylenimine is aqueous, for example, the amounts can be adjusted accordingly to compensate for % actives dilution as would be understood in the art.

### Acid Component

In certain embodiments, the cleaning composition further includes an acid component which may include lactic acid. Lactic acid may also referred to as a lactic acid antibacterial agent of the cleaning composition. Lactic acid is useful as an antibacterial agent, especially in embodiments of the cleaning composition which are free of a conventional antibacterial component. The cleaning composition including the lactic acid exhibits antibacterial properties against various species of bacteria. Non-limiting examples of species of bacteria, in which the cleaning composition exhibits antibacterial properties against, include E. coli, P. aeruginosa, S. aureus, and E. hirae.

The lactic acid may also be referred to in the art as milk acid or 2-hydroxypropanoic acid. A non-limiting example of a suitable lactic acid is commercially available from Purac of Lincolnshire, Ill., under the trademark PURAC®, such as PURAC® Sanilac. It is to be appreciated that other suitable lactic acids are commercially available from other sources.

The lactic acid is typically present in the cleaning composition in an amount of at least 1, at least 1.5, at least 2, at least 2.5, or of from 1 to 5, 2 to 5, 2 to 4, or 2 to 3, wt. %, each based on a total weight of the cleaning composition, or any value or range of values therebetween. Typically, the amounts described herein are based on the assumption that the lactic acid includes 100% actives. As such, if the lactic acid is aqueous, for example, the amounts can be adjusted accordingly to compensate for % actives dilution as would be understood in the art. The lactic acid is useful as an antibacterial (or antimicrobial) agent. The lactic acid may also be useful as a preservative. In related embodiments, the lactic acid is utilized in an amount sufficient such that the cleaning composition has a pH of no greater than 7, no greater than 6, no greater than 5, no greater than 4, no greater than 3, or no greater than 2, or any range therebetween.

In various embodiments, the cleaning composition further includes a supplemental acid different from the acid component or the lactic acid. The supplemental acid is useful for lowering pH of the cleaning composition. In general, the supplemental acid is less costly than the lactic acid, which improves the overall cost of the cleaning composition. The supplemental acid can be of any type, including inorganic and organic acids. Utilizing the acid(s) allows for the cleaning composition to be provided without preservatives.

Examples of suitable inorganic acids include: sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, hydrochloric acid, and sulfamic acid. In specific embodiments utilizing the supplemental acid, the cleaning composition includes sulfuric acid in addition to the lactic acid.

Examples of suitable organic acids include those which include at least one carbon atom, and include at least one carboxyl group in its structure. Specific examples include water soluble organic acids which contain from 1 to 6 carbon atoms, and at least one carboxyl group as noted and further useful organic acids include: linear aliphatic acids such as formic acid, acetic acid, propionic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, alpha-hydroxybutyric acid, glyceric acid, tartronic acid, malic acid, tartaric acid and citric acid, as well as acid salts of these organic acids.

If utilized in the cleaning composition, the supplemental acid is typically present in the cleaning composition in an amount of at least 1, at least 1.5, at least 2, at least 2.5, or of from 1 to 5, 2 to 5, 2 to 4, 2 to 3, or 2.5, wt. %, each based on a total weight of the cleaning composition, or any value or range of values therebetween. Typically, the amounts described herein are based on the assumption that the supplemental acid includes 100% actives. As such, if the supplemental acid is aqueous, for example, the amounts can be adjusted accordingly to compensate for % actives dilution as would be understood in the art. In related embodiments, the supplemental acid is utilized in an amount sufficient such that the cleaning composition has a pH of no greater than 7, no greater than 6, no greater than 5, or no greater than 4, or any range therebetween, prior to incorporation/presence of the lactic acid component.

In various embodiments described further below, the supplemental acid is utilized to form the cleaning composition prior to inclusion the lactic acid. These embodiments are useful for preventing the lactic acid from prematurely reacting with another component (e.g. a base, a contaminant, etc.), which may be imparted by one or more of the surfactant components. In this way, the supplemental acid can be used to react with such components first (if present), which can be beneficial in a cost sense (assuming the lactic acid is more costly than the supplemental acid). The supplemental acid is also useful for counteracting (initial) alkalinity of the cleaning composition which may be imparted by one or more of the surfactant components. For example, a sufficient amount of the supplemental acid can be utilized during formation of the cleaning composition to swing the cleaning composition from alkaline to acidic, and then a sufficient amount of lactic acid can be used to obtain a final (acidic) pH of the cleaning composition.

### Surfactants

The terminology “surfactant actives component” describes all components of the cleaning composition having surfactant actives. Non-limiting examples of suitable components having surfactant actives include anionic surfactants, betaines, amine oxides, nonionic surfactants, amphoteric surfactants, zwitterionic surfactants, cationic surfactants, ionic surfactants, primary surfactants, secondary surfactants, supplemental surfactants, and co-surfactants. Surfactants are commonly described as a “primary surfactant,” “secondary surfactant,” “supplemental surfactant,” or “co-surfactant” based on the cleansing power of the surfactant. The surfactant actives component includes all surfactant actives in the cleaning composition. For example, if the cleaning composition includes an anionic surfactant, a betaine, and a nonionic surfactant, the total surfactant actives concentration of the cleaning composition includes the surfactant actives for the anionic surfactant, the betaine, and the nonionic surfactant.

In certain embodiments, the cleaning composition includes the surfactant actives component in an amount of at least 20, 25, 30, 35, 40, 45, or 50, or of from 20 to 80, 20 to 50, 20 to 40, 20 to 30, or 20 to 25, wt. %, each based on a total weight of the cleaning composition, or any value or range of values therebetween. In other embodiments, the total wt. % of the anionic surfactant, the additional surfactant, the betaine, and the amine oxide is in the surfactant actives component in an amount of at least 20, 25, 30, 35, 40, 45, or 50, or of from 20 to 80, 20 to 50, 20 to 40, 20 to 30, or 20 to 25, wt. %, each based on a total weight of the cleaning composition, or any value or range of values therebetween. In further embodiments, the total wt. % of the anionic surfactant, the betaine, and the nonionic surfactant is in the surfactant actives component in an amount of at least 20, 25, 30, 35, 40, 45, or 50, or of from 20 to 80, 20 to 50, 20 to 40, 20 to 30, or 20 to 25, wt. %, each based on a total weight of the cleaning composition, or any value or range of values therebetween.

As one example wherein the surfactant actives component only includes the anionic surfactant in an amount of 15 wt. % and the betaine in an amount of 6 wt. %, the total wt. % of the anionic surfactant and the betaine in the surfactant actives component is in an amount of 21 wt. % which is at least 20 wt. %. As a further example wherein the surfactant actives component only includes the anionic surfactant in an amount of 10 wt. %, the betaine in an amount of 4 wt. %, and the additional surfactant in an amount of 8 wt. %, the total wt. % of the anionic surfactant, the betaine, and the additional surfactant in the surfactant actives component is in an amount of 22 wt. % which is at least 20 wt. %.

The surfactants can be in various ratios relative to one another, provided that each of the surfactants are individually present within their respective ranges described above. Typically, a higher surfactant actives concentration results in a cleaning concentration having a higher viscosity due to inter- and intra-molecular forces between one or more surfactants.

Referring now to the anionic surfactant, the surfactant actives component of the cleaning composition includes the anionic surfactant. The anionic surfactant may be described as a “primary” surfactant of the cleaning composition. The anionic surfactant can include or be any of the surfactants commonly classified as anionic surfactants. These surfactants can include the alkali metal, ammonium, and magnesium salts of the alpha olefin sulfonates, alkyl sulfonates, alkyl aryl sulfonates, alkyl aryl ether sulfates, alkyl sulfates, alkyl ether sulfates, sulfated alcohols, and sulfated alcohol ethoxylates, taurates, petroleum sulfonates, alkyl naphthalene sulfonates, alkyl sarcosinates, and the alkyl sulfosuccinates in which the alkyl group is a long chain 8 to 22, more typically 10 to 18, carbon atom group and the aryl group is typically phenyl or naphthyl.

Typical anionic surfactants include sodium lauryl sulfonate, ammonium lauryl sulfonate, ammonium lauryl sulfate, dodecyl benzene sulfonate, linear alkylbenzene sulfonate (i.e., “LAS” or “LAS acid”), sodium lauryl sulfate (i.e., “SLS”), sodium laureth sulfate, sodium lauryl ether sulfate (i.e., “SLES”), sodium lauryl myristyl sulfate, diethanolamine lauryl sulfate, ammonium salts of sulfated alcohol ethoxylates, sodium cocoyl isethionate, sodium N-methyl-N-oleyl taurate, sodium N-methyl-N-cocoyl taurate, triethanolamine lauryl sulfate, disodium monooleamide PEG-2 sulfosuccinate, sodium xylene sulfonate, petroleum sulfonates sodium salt, alkyl naphthalene sodium sulfonates, sodium lauroyl sarcosinate, and sodium alkyl sulfosuccinate. In various embodiments, the anionic surfactant utilized for the cleaning composition comprises, consists essentially of, consists of, or is, a SLS, a SLES, a LAS, or combinations thereof. In specific embodiments, the anionic surfactant utilized for the cleaning composition comprises, consists essentially of, or consists of, or is, a SLS. In other embodiments, the anionic surfactant utilized for the cleaning composition comprises, consists essentially of, or consists of, or is, a SLES.

In various embodiments, the anionic surfactant is classified as a fatty alcohol sulfate (i.e., a “FAS”). In certain embodiments, the anionic surfactant is a FAS having the general formula I below:

R₁OSO₃M (I)

wherein R₁ is generally an alkyl group having from 10 to 11 carbon atoms, and M is chosen from alkali metals, alkaline earth metals, and combinations thereof.

If utilized as (or in) the anionic surfactant, the fatty alcohol sulfate may be prepared in any manner known in the art, such as by reaction of the corresponding alcohol component with a sulfating agent, more typically with a sulfur trioxide or chlorosulfonic acid, and subsequent neutralization, generally with alkali bases, ammonium bases or alkyl- or hydroxyalkyl-substituted ammonium bases. In one embodiment utilizing FAS, the FAS is prepared by mixing sodium lauryl sulfate having 12 carbon atoms as its primary carbon chain, with sodium n-decyl sulfate having 10 carbon atoms as its primary carbon chain in a wt. % actives ratio of from 5:1 to 1:5, and more typically 1:1, respectively.

Non-limiting examples of suitable anionic surfactants are commercially available from BASF Corporation of Florham Park, N.J., under the trade name STANDAPOL®, such as STANDAPOL® WAQ-LCK, and under the trade name TEXAPON®, such as TEXAPON® N 70 and TEXAPON® 842 UP. It is to be appreciated that the anionic surfactant can include a mixture of two or more of the anionic surfactants described herein. Further suitable anionic surfactants, for purposes of various embodiments of the present disclosure, are described below.

In certain embodiments, the anionic surfactant may be a hydrotrope. If utilized, the hydrotrope is typically useful for increasing stability of the cleaning composition, which also tends to relate to cloud point (or compatibility index) of the cleaning composition. The hydrotrope may also be useful for adjusting viscosity of the cleaning composition. If utilized, various types of hydrotropes can be included in the cleaning composition, even those not generally described as anionic surfactants. Examples of suitable hydrotropes include sulfonates, such as xylene sulfonates (e.g. sodium xylene sulfonate), cumene sulfonates, and dihexyl sodium sulfonate; alkyl sulfates, such as sodium alkyl sulfates, e.g. sodium octyl sulfate; urea; isopropanol and other alcohols; alcohol alkoxylates; glycols, such as hexylene glycol and propylene glycol; and those hydrotropes described in U.S. Pat. No. 3,563,901 to Crotty and U.S. Pat. No. 4,443,270 to Baird et al., the disclosures of which are expressly incorporated herein by reference in their entirety in various non-limiting embodiments. Non-limiting examples of suitable hydrotropes are commercially available from BASF Corporation, under the trade name TEXAPON®, such as TEXAPON® 842 and TEXAPON® 842 UP. In specific embodiments, the anionic surfactant utilized for the cleaning composition comprises, consists essentially of, consists of, or is, a sodium alkyl sulfate.

The anionic surfactant is typically present in the surfactant actives component of the cleaning composition in an amount of from 1 to 99, 1 to 35, 1 to 30, 1 to 25, 5 to 20, 8 to 17, or 10 to 15, wt. %, each based on a total weight of the cleaning composition, or any value or range of values therebetween. Typically, the amounts described herein are based on the assumption that the anionic surfactant includes 100% actives. As such, if the anionic surfactant is aqueous, for example, the amounts can be adjusted accordingly to compensate for % actives dilution as would be understood in the art.

Referring now to the betaine, the surfactant actives component of the cleaning composition may include the betaine. The betaine is an amphoteric surfactant and may be described as a “supplemental” surfactant of the cleaning composition. The betaine can be especially useful as a foam stabilizer. In other words, these surfactants generally make foam last longer during use of the cleaning composition. The betaine described herein can also be useful for other purposes, such as for cutting grease during use of the cleaning composition.

Examples of suitable betaines can include alkyl betaines, alkylamidobetaine, amidazoliniumbetaine, sulfobetaine (INCI Sultaines) as well as the phosphobetaine, ricinoleamidopropyl betaine, cocamidopropyl betaine, oleyl betaine, stearyl betaine, cocoamidopropyl hydroxy sultaine, lauric myristic betaine, cocoamidosulfobetaine, alkylamidophospho betaine, algal oil betaine, and combinations thereof. In specific embodiments, the betaine comprises, consists essentially of, consists of, or is, a cocoamido alkyl betaine, such as a cocoamido propyl betaine. Non-limiting examples of suitable betaines are commercially available from BASF Corporation, under the trade name DEHYTON®, such as DEHYTON® PK 45 and DEHYTON® AO 45.

If utilized in the cleaning composition, the betaine is typically present in the surfactant actives component of the cleaning composition in an amount of from 0.1 to 99, from 0.1 to 7, from 0.1 to 5, from 0.5 to 5, or from 1 to 3, wt. %, each based on a total weight of the cleaning composition, or any value or range of values therebetween. Typically, the amounts described herein are based on the assumption that the betaine includes 100% actives. As such, if the betaine is aqueous, for example, the amounts can be adjusted accordingly to compensate for % actives dilution as would be understood in the art.

Referring now to the amine oxide, the surfactant actives component of the cleaning composition may include the amine oxide. The amine oxide may also be described as a supplemental surfactant of the cleaning composition. The amine oxide can be especially useful as a foam stabilizer. In other words, these surfactants generally make foam last longer during use of the cleaning composition. The amine oxide described herein can also be useful for other purposes, such as for cutting grease during use of the cleaning composition. Amine oxides are not typically utilized in cleaning compositions having an acidic pH such as a pH of no greater than 4, 3, 2, or 1 due to protonation which can negatively impact the performance of the amine oxide in the cleaning composition.

Examples of suitable amine oxides include coco dimethyl amine oxide or coco amido propyl dimethyl amine oxide. Amine oxide may have a linear or mid-branched alkyl moiety. Non-limiting examples of suitable amine oxides are commercially available from BASF Corporation, under the trade name DEHYTON®, such as DEHYTON® CAW.

If utilized in the cleaning composition, the amine oxide is typically present in the surfactant actives component of the cleaning composition in an amount of from 0.1 to 99, from 0.1 to 7, from 0.1 to 5, from 0.5 to 5, or from 1 to 3, wt. %, each based on a total weight of the cleaning composition, or any value or range of values therebetween. In certain embodiments, the amine oxide is present in the surfactant actives component of the cleaning composition in an amount of from 0 to 6, from 0 to 5, from 0 to 4, from 0 to 3, from 0 to 2, from 0 to 1, or from 0 to 0.1, wt. %, each based on a total weight of the cleaning composition, or any value or range of values therebetween. It is to be appreciated that when the amine oxide is present in the surfactant actives component in an amount of 0 wt %, as described in the ranges above, the cleaning composition is free of the amine oxide and, therefore, the amine oxide is not present in the cleaning composition. In various embodiments, the amine oxide is optional in the surfactant actives component of the cleaning composition. Typically, the amounts described herein are based on the assumption that the amine oxide includes 100% actives. As such, if the amine oxide is aqueous, for example, the amounts can be adjusted accordingly to compensate for % actives dilution as would be understood in the art.

Referring now to the nonionic surfactant, the surfactant actives component of the cleaning composition may include the nonionic surfactant. The surfactant actives component can include any of the surfactants commonly classified as nonionic surfactants. The nonionic surfactant may also be described as a “primary” surfactant of the cleaning composition (along with the anionic surfactant described above). Suitable nonionic surfactants can include an alkyl polyglycoside (i.e., an “APG”), such as APGs having the general formula II:

R₂O(R₃O)_{b}(Z)ₐ (II)

wherein R₂ is a generally monovalent organic radical having from 6 to 30 carbon atoms, R₃ is generally a divalent alkylene radical having from 2 to 4 carbon atoms, Z is generally a saccharide residue having 5 or 6 carbon atoms, b is generally a number having a value of from 0 to 12, and a is generally a number having a value of from 1 to 6. Other types of APGs can also be utilized.

Many suitable APGs are commercially available, for example, as GLUCOPON® or PLANTAREN® surfactants from BASF Corporation. Examples of such surfactants include, but are not limited, to: GLUCOPON® 225 DK, GLUCOPON® 425N, GLUCOPON® 625 UP, APG® 325N, GLUCOPON® 600 CS UP, GLUCOPON® 600 UP, PLANTAREN® 2000N UP, PLANTAREN® 1300, GLUCOPON 215 UP, and GLUCOPON 420 UP.

Other examples include APG surfactant compositions which may include mixtures of compounds of formula II wherein: Z represents a moiety derived from a reducing saccharide containing 5 or 6 carbon atoms; a is a number having a value from 1 to 6; b is zero; and R1 is an alkyl radical having from 8 to 20 carbon atoms. The compositions can have increased surfactant properties and an HLB in the range of 10 to 16 and a non-Flory distribution of glycosides, which is includes a mixture of an alkyl monoglycoside and a mixture of APGs having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside. The composition may have an average degree of polymerization of 1.8 to 3. Such compositions, also known as “peaked” APGs, can be prepared by separation of the monoglycoside from the original reaction mixture of alkyl monoglycoside and APGs after removal of the alcohol. This separation may be carried out by molecular distillation and normally results in the removal of 70-95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690 to McCurry, Jr. et al., the disclosure of which is expressly incorporated herein by reference in its entirety in various non-limiting embodiments.

Other APGs which can be used are those in which the alkyl moiety include from 6 to 18 carbon atoms in which the average carbon chain length of the composition is from 9 to 14 including a mixture of two or more of at least binary components of APGs, wherein each binary component is present in the mixture in relation to its average carbon chain length in an amount effective to provide the surfactant composition with the average carbon chain length of 9 to 14 and wherein at least one, or both binary components, include a Flory distribution of polyglycosides derived from an acid-catalyzed reaction of an alcohol including 6 to 20 carbon atoms and a suitable saccharide from which excess alcohol has been separated. In one embodiment, the APG is of the type in general formula II wherein: R₂ is a monovalent organic radical having from 8 to 16 carbon atoms; Z is a saccharide residue having 5 or 6 carbon atoms; b is zero; and a is a number having a value of 1.55.

Further examples of suitable alkyl polyglycosides (APGs), fatty alcohol sulfates (FASs), and/or other surfactants, for purposes of the present disclosure, are described in U.S. Pat. No. 5,773,406 to Gross, the disclosure of which is expressly incorporated herein by reference in its entirety in various non-limiting embodiments. Further examples of suitable surfactants and/or additional optional components, for purposes of the present disclosure, are described in U.S. Pat. No. 6,087,320 to Urfer et al.; U.S. Pat. No. 7,186,675 to Meine et al.; U.S. Pat. No. 7,348,302 to Smith; U.S. Pat. No. 7,666,826 to Smith et al.; U.S. Pat. No. 7,745,384 to Perry et al.; U.S. Pat. No. 7,998,918 to Rong et al.; U.S. Pat. No. 8,232,236 to Jaynes et al; and U.S. Pat. No. 8,283,304 to Saint Victor; the disclosures of which are expressly incorporated herein by reference in their entirety in various non-limiting embodiments. Yet further examples of suitable surfactants and/or additional optional components, for purposes of the present disclosure, are described in US Pat. App. Pub. No. 2010/0197553 to Barnabas et al., the disclosure of which is expressly incorporated herein by reference in its entirety in various non-limiting embodiments.

In various embodiments, the nonionic surfactant utilized for the cleaning composition comprises, consists essentially of, consists of, or is, an APG. In other embodiments, the nonionic surfactant utilized for the cleaning composition comprises, consists essentially of, or consists of, or is, lauryl/myristyl glucoside. It is to be appreciated that the nonionic surfactant can include a mixture of two or more of the nonionic surfactants described herein. Further suitable nonionic surfactants, for purposes of various embodiments of the present disclosure, are described below.

If utilized in the cleaning composition, the nonionic surfactant is typically present in the surfactant actives component of the cleaning composition in an amount of from 1 to 99, 1 to 35, 1 to 25, 1 to 20, 1 to 15, 5 to 15, or 5 to 12, wt. %, each based on a total weight of the cleaning composition, or any value or range of values therebetween. Typically, the amounts described herein are based on the assumption that the nonionic surfactant includes 100% actives. As such, if the nonionic surfactant is aqueous, for example, the amounts can be adjusted accordingly to compensate for % actives dilution as would be understood in the art. In specific embodiments, the anionic and nonionic surfactants are present in the surfactant actives component of the cleaning composition in a wt. % ratio of 1:1. Other ratios may also be utilized.

Optionally, in various embodiments, the surfactant actives component of the cleaning composition further includes supplemental surfactants different from the anionic surfactants, the nonionic surfactants, the betaine, and the amine oxide described above. The supplemental surfactant can include any type of conventional surfactant understood in the art. The supplemental surfactant may also be referred to in the art as a “secondary” surfactant or a co-surfactant, and may be useful for a variety of purposes, such as for boosting cleaning performance of the cleaning composition. If utilized, the supplemental surfactant is typically chosen from the group of nonionic surfactants, anionic surfactants, amphoteric surfactants, cationic surfactants, and ionic surfactants. It is to be appreciated that other types of surfactants can also be used.

Nonionic surfactants, suitable as the supplemental surfactant, include block copolymers such as polyalkylene oxide surfactants (also known as polyoxyalkylene surfactants or polyalkylene glycol surfactants). Suitable polyalkylene oxide surfactants include polyoxypropylene surfactants and polyoxyethylene glycol surfactants. Suitable surfactants of this type are synthetic organic polyoxypropylene (PO)-polyoxyethylene (EO) block copolymers. These surfactants generally include a di-block polymer including an EO block and a PO block, a center block of polyoxypropylene units (PO), and having blocks of polyoxyethylene grafted onto the polyoxypropylene unit or a center block of EO with attached PO blocks. Further, this surfactant can have further blocks of either polyoxyethylene or polyoxypropylene in the molecules. The surfactant may also include butylene oxide (BO) blocks, and can include random incorporations of two or three alkylene oxides, e.g. EO/PO/BO, EO/PO/PO, EO/EO/PO, etc. Such surfactants may be referred to in the art as “heteric” block surfactants.

In certain embodiments, the supplemental surfactant includes an ethylene oxide-propylene oxide (EO/PO) block copolymer and/or a reverse EO/PO block copolymer, i.e., a PO/EO block copolymer. Specific examples of suitable block copolymers include: straight block polymeric glycols obtained, for example, by the addition of ethylene oxide (EO) to a condensation product of propylene oxide (PO) with propylene glycol; and reverse block copolymers obtained, for example, by adding ethylene oxide to ethylene glycol to provide a hydrophile of designated molecular weight, and adding polypropylene oxide to obtain hydrophobic blocks on the outside of the molecule. Reversing the hydrophobic and hydrophilic blocks of the copolymer PO/EO/PO creates surfactants similar to the regular EO/PO/EO block copolymers. These block copolymers may also be referred to in the art as polaxamers or triblock copolymers.

Additional nonionic surfactants, suitable as the supplemental surfactant, include alcohol alkoxylates. Suitable alcohol alkoxylates include linear alcohol ethoxylates. Additional alcohol alkoxylates include alkylphenol ethoxylates, branched alcohol ethoxylates, secondary alcohol ethoxylates, castor oil ethoxylates, alkylamine ethoxylates (also known as alkoxylated alkyl amines), tallow amine ethoxylates, fatty acid ethoxylates, sorbital oleate ethoxylates, end-capped ethoxylates, or combinations thereof. Further nonionic surfactants include amides such as fatty alkanolamides, alkyldiethanolamides, coconut diethanolamide, lauramide diethanolamide, cocoamide diethanolamide, polyethylene glycol cocoamide, oleic diethanolamide, or combinations thereof. Yet further nonionic surfactants include polyalkoxylated aliphatic base, polyalkoxylated amide, glycol esters, glycerol esters, amine oxides, phosphate esters, alcohol phosphate, fatty triglycerides, fatty triglyceride esters, alkyl ether phosphate, alkyl esters, alkyl phenol ethoxylate phosphate esters, alkyl polysaccharides, block copolymers, alkyl polyglucocides, or combinations thereof. In certain embodiments, the cleaning composition is free of alcohol alkoxylates. Alcohol alkoxylates are typically utilized in laundry detergents and not in cleaning compositions for dishwashing.

Amphoteric surfactants, suitable as the supplemental surfactant, include imidazoline derivatives and the like. Typical amphoteric surfactants include stearyl amphocarboxy glycinate, sodium lauraminopropionate, disodium lauryliminodipropionate, tallowiminodipropionate, cocoampho-carboxy glycinate, cocoimidazoline carboxylate, lauric imidazoline monocarboxylate, lauric imidazoline dicarboxylate, and the like.

Further non-limiting examples of suitable surfactant components, for purposes of the present disclosure, are commercially available from BASF Corporation, under the trade name LUTENSOL®, such as LUTENSOL® XP 80, LUTENSOL® XL 80, LUTENSOL® TO 8, and LUTENSOL® GD 70; under the trade name TETRONIC®, such as TETRONIC® 304; under the trade name of PLURONIC®, such as PLURONIC® 25R2, PLURONIC® 17R2, and PLURONIC® 25R4; under the trade name DEHYPON®, such as DEHYPON® LS-36 and DEHYPON® LS-54; under the trade name PLURAFAC®, such as PLURAFAC® LF 900, PLURAFAC® SLF 180, PLURAFAC® RA-40, and PLURAFAC® LF 711; under the trade name of PLANTOPON®, such as PLANTAPON® 611 L; as well as under the trade name LUTENSIT®, such as LUTENSIT® AS 2230.

Further non-limiting examples of suitable surfactant components are commercially available from Huntsman, under the trade names of EMPILAN®, such EMPILAN® KB and EMPILAN® KC; SURFONIC® L12; TERIC® 12A; and ECOTERIC®, such as ECOTERIC® B30 and ECOTERIC® B35. Further non-limiting examples of suitable surfactant components are commercially available from Croda, under the trade name of NatSurf™, such as NatSurf™ 265. Further non-limiting examples of suitable surfactant components are commercially available from Stepan, under the trade name of BIO-SOFT®, including the BIO-SOFT® N1, N23, and N91 series. Yet further non-limiting examples of suitable surfactant components are commercially available from Air Products, under the trade names of NONIDET® and TOMADOL®. Combinations of two or more different surfactants may be used in the cleaning composition.

If utilized in the cleaning composition, the supplemental surfactant can be present in the surfactant actives component of the cleaning composition in various amounts. In certain embodiments, the supplemental surfactant is present in the cleaning composition in an amount of from 1 to 10, 1 to 7.5, 1 to 5, or 1 to 3, wt. %, each based on a total weight of the cleaning composition, or any value or range of values therebetween. Typically, the amounts described herein are based on the assumption that the supplemental surfactant includes 100% actives. As such, if the supplemental surfactant is aqueous, for example, the amounts can be adjusted accordingly to compensate for % actives dilution as would be understood in the art.

Referring now to the additional surfactant, the surfactant actives component of the cleaning composition may include the additional surfactant. The additional surfactant may include at least one surfactant described above. In certain embodiments, the additional surfactant includes the nonionic surfactant. In various embodiments, the additional surfactant is free of the betaine, the amine oxide, or the combination thereof.

If utilized in the cleaning composition, the additional surfactant is typically present in the surfactant actives component of the cleaning composition in an amount of from 1 to 99, 1 to 35, 1 to 30, 1 to 25, 5 to 20, 8 to 17, or 10 to 15, wt. %, each based on a total weight of the cleaning composition, or any value or range of values therebetween. In certain embodiments, the additional surfactant is present in the surfactant actives component of the cleaning composition in an amount of from 0 to 99, from 0 to 35, from 0 to 30, from 0 to 25, from 0 to 20, from 0 to 17, or from 0 to 15, wt. %, each based on a total weight of the cleaning composition, or any value or range of values therebetween. It is to be appreciated that when the additional surfactant is present in the surfactant actives component in an amount of 0 wt %, as described in the ranges above, the cleaning composition is free of the additional surfactant and, therefore, the additional surfactant is not present in the cleaning composition. In various embodiments, the additional surfactant is optional in the surfactant actives component of the cleaning composition. Typically, the amounts described herein are based on the assumption that the amine oxide includes 100% actives. As such, if the amine oxide is aqueous, for example, the amounts can be adjusted accordingly to compensate for % actives dilution as would be understood in the art.

### Alcohols

Alcohols, along with other viscosity modifiers, such as such as glycol ethers and short chain surfactants, are typically utilized in conventional cleaning compositions to reduce the viscosity of the conventional cleaning compositions. However, due to the flammability of alcohols, the amount of alcohol in the cleaning composition is minimized and may be eliminated. The cleaning composition includes less than 0.1, 0.05, or 0.01 wt. % of alcohol, each based on a total weight of the cleaning composition. In certain embodiments, the cleaning composition is free of alcohol. Examples of such alcohols include, but are not limited to, monohydric alcohols, such as ethanol, isopropanol, methanol, butyl alcohol, and the like, and polyhydric alcohols, such as ethylene glycol, propylene glycol, glycerol, and the like. Other examples of such alcohols include, but are not limited to, n-butanol, iso-butanol, 2-ethyl hexanol, 2-propyl heptanol, butyl glycol, butyl diethyleneglycol, butyl triethyleneglycol, butyl propyleneglycol, butyl dipropyleneglycol, butyl tripropyleneglycol, methyl diglycol, methyl triglycol, methyldipropyleneglycol, methyldipropyleneglycol, and propanol (e.g. 1-propanol and/or isopropyl alcohol).

### Diluent(s)

The cleaning composition typically includes at least one diluent. Examples of suitable diluents include water. The diluent is useful as a filler component (e.g. for cost purposes) as well as for adjusting viscosity of the cleaning composition.

The water can be of various types. In certain embodiments, the water is demineralized. The water is present in the composition in various amounts, depending on the embodiment. The water can be added to the composition as a separate component. However, some of the water can also be imparted by one of the other components, such as by one of more of the surfactant components, the alkoxylated polyethylenimine, and/or the lactic acid, if aqueous in nature.

The water can be present in the cleaning composition in various amounts. In certain embodiments, the water is present in the cleaning composition in an amount of from 1 to 80, 20 to 80, 40 to 80, 60 to 80, or 70 to 80, wt. %, each based on a total weight of the cleaning composition, or any value or range of values therebetween.

### Additive(s)

Optionally, the cleaning composition may include one or more additives. Any type of additive can be utilized, especially additives which are conventionally used in dishwashing applications. Examples of suitable additives include supplemental builder components such as metal citrates, enzymes, salts, dispersants, polymers, soil release polymers, cleaning polymers, complexing agents, fragrances, preservatives, fillers, inorganic extenders, formulation auxiliaries, solubility improvers, dyes, corrosion inhibitors, peroxide stabilizers, electrolytes, soaps, detergents, perfumes, oils, oxidizing agents such as perborates, dichloroisocyanurates, interface-active ethyleneoxy adducts, and combinations thereof. The cleaning composition is not limited to any particular type of additive, and if utilized in the cleaning composition, the additive (or additives) can be present in various amounts understood in the art.

Salts, such as sodium chloride (NaCl), may be utilized in the cleaning composition to increase the viscosity of the cleaning composition. Other salts, such as sodium sulfate, ammonium chloride, potassium chloride, etc., may also be in the cleaning composition to increase the viscosity of the cleaning composition. The salt can be present in the cleaning composition in various amounts. In certain embodiments, the salt is present in the cleaning composition in an amount of from 0.1 to 10, 0.5 to 5, or 1 to 3, wt. %, each based on a total weight of the cleaning composition, or any value or range of values therebetween.

### Physical Properties of the Cleaning Composition

As introduced above, the cleaning composition is generally in the form of a liquid. In various embodiments, the cleaning composition has a viscosity of from 100 to 1200, 200 to 1000, 300 to 900, 400 to 800, 500 to 700, millipascal-second (mPa·s) at 23° C. due to the viscosity reducing properties of the alkoxylated polyethylenimine. Viscosity of the cleaning composition can be determined by conventional methods understood in the art.

The cleaning composition may have any pH commonly known in the art for cleaning composition. In certain embodiments, such as embodiments utilizing lactic acid, the cleaning composition is generally acidic in nature based on the presence of the acid component(s). Specifically, the cleaning composition typically has a pH of no greater than 4, of no greater than 3.5, or no greater than 3, or a pH of from 1 to 4, 2 to 4, 2.5 to 3.5, 2.8 to 3.5, 2.8 to 3.2, or 3. The pH of cleaning composition can be determined by conventional methods understood in the art.

In embodiments utilizing the lactic acid, the pH of the cleaning composition is generally imparted by at least the lactic acid, and if present, supplemental acid component as well. The acidic nature of the cleaning composition allows for the exclusion of (other) antibacterial components, as well as provides some degree of cleaning efficacy for the cleaning composition.

### Cleaning/Foaming Efficacy of the Cleaning Composition

Without being bound or limited by any particular theory, it is believed that a synergy exists between the surfactant components and the alkoxylated polyethylenimine of the cleaning composition. Specifically, in addition to the reduced viscosity of the cleaning composition, the combination of components provides for increased plate washing capability relative to conventional cleaning composition.

The number of plates is determined via a plate test, such as by ASTM D4009, Method A, Soil B. Typically, the cleaning composition provides for at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, or at least 28 or from 1 to 40, 10 to 35, 20 to 30, 22 to 30, or 24 to 28, plates, or any number of plates therebetween. In general, an increase in the number of plates is indicator of improved cleaning performance for the cleaning composition. Further properties can be appreciated with reference to the Example section below.

### Antibacterial Effectiveness

In embodiments of cleaning composition including lactic acid, the cleaning composition exhibits antibacterial properties against various species of bacteria. The effectiveness of the antibacterial properties exhibited by the cleaning composition is determined according to EN 1276, Quantitative Suspension of Bactericidal Activity of Chemical Disinfectants. Under EN 1276, the cleaning composition including lactic acid may be evaluated to determine the bactericidal activity (i.e., antibacterial properties) of the cleaning composition against E. coli, P. aeruginosa, S. aureus, and E. hirae. For the cleaning composition to be considered “effective” under EN 1276, the cleaning composition must provide at least a 5 log reduction of bacteria in no greater than 5 minutes.

Typically, the cleaning composition provides a 5 log reduction of bacteria in no greater than 5, no greater than 4.5, no greater than 4, no greater than 3.5, no greater than 3, no greater than 2.5, no greater than 2, no greater than 1.5, or no greater than 1, minute(s), or any number of minutes therebetween. In general, a decrease in the number of minutes is an indicator of improved antibacterial properties. Typically, exposure of bacteria to the cleaning composition for 5 minutes provides a greater than 5 log, greater than 5.5 log, a greater than 6 log, a greater than 6.5 log, or a greater than 7 log, reduction of bacteria, or any number of reduction of bacteria therebetween. In general, an increase in the number of reduction of bacteria is an indicator of improved antibacterial properties.

### Additional Embodiments

In certain embodiments, the cleaning composition is substantially free of an antibacterial component. In addition, or alternatively, the cleaning composition may be substantially free of a preservative. Such components are generally understood in the art. For example, triclosan and PCMX are common antibacterial components. Such components are generally not necessary in the cleaning composition based on its pH, which is imparted by presence of the lactic acid. Should an antibacterial component (and/or preservative) be present in the cleaning composition, the level of antibacterial component in the cleaning composition is typically less than 0.5, less than 0.1, or less than 0.01, wt. %, each based on 100 parts by weight of the cleaning composition, or any value or range of values therebetween. In certain embodiments, the cleaning composition completely excludes an antibacterial component (and/or preservative). It is to be appreciated that the lactic acid is not included in this exclusion.

In certain embodiments, the cleaning composition is substantially free of phosphorus-containing compounds, making the cleaning composition more environmentally acceptable. The terminology “phosphorus-free” refers to a composition, mixture, or ingredients to which phosphorus-containing compounds are not added. Should phosphorus-containing compounds be present through contamination of a phosphorus-free composition, mixture, or ingredient, the level of phosphorus-containing compounds in the resulting cleaning composition is typically less than 0.5, less than 0.1, or less than 0.01, wt. %, each based on a total weight of the cleaning composition, or any value or range of values therebetween. In various embodiments, the cleaning composition is free of phosphorus-containing compounds.

In various embodiments, the cleaning composition is free of a chlorine-containing component. Examples of components containing chlorine include chlorine bleaches, which generally belong to a group of strong oxidizing agents, all of which have one or more chlorine atoms in their molecule. Specific examples of chlorine bleaches used in the art include chlorinated isocyanurates, chlorinated trisodium phosphate, hypochlorite, and sodium hypochlorite. The terminology “free of a chlorine-containing component” describes that the cleaning composition is free of a purposefully added component including chlorine, such as the addition of chlorine bleach, e.g. sodium hypochlorite. In some embodiments, the cleaning composition includes some trace amount of chlorine, such as a trace amount of chlorine present in one or more of the components.

In various embodiments, the cleaning composition includes chlorine in an amount of from 0.50 to approaching zero (0), 0.25 to approaching 0, or 0.10 to approaching 0, wt. %, each based on a total weight of the cleaning composition, or any value or range of values therebetween. In certain embodiments, the cleaning composition completely excludes chlorine.

In various embodiments, the cleaning composition is free of a bleach component. While chlorine bleaches tend to be commonly used bleach components, other bleaches include non-chlorine bleaches, such as peroxygen compounds, which release active oxygen in wash water. Further examples of non-chlorine bleaches include perborates/sodium perborates, potassium monopersulfates, sodium percarbonates, hydrogen peroxides, and organic peracids. In various embodiments, the cleaning composition includes the bleach component in an amount of from 15 to approaching zero (0), 10 to approaching 0, 5.0 to approaching 0, or 1.0 to approaching 0, wt. %, each based on a total weight of the cleaning composition, or any value or range of values therebetween. In certain embodiments, the cleaning composition completely excludes the bleach component.

In various embodiments, the cleaning composition of this disclosure is not suitable and therefore not utilized as a laundry detergent (i.e., “HDL”). Laundry detergents, as are understood in the art, typically include alkaline builders. Non-limiting examples of alkaline builders typically utilized in laundry detergents include sodium carbonate, sodium silicate, sodium hydroxide (NaOH), monoethanolamine (MEA), triethanolamine (TEA), or combinations thereof. In certain embodiments, the cleaning composition includes less than 5, 1. 0.5, or 0.1, weight percent (wt. %) of the alkaline builders typically utilized in laundry detergents. In other embodiments, the cleaning composition is free of the alkaline builders typically utilized in laundry detergents.

Laundry detergents, as are understood in the art, also typically include optical brighteners. Non-limiting examples of optical brighteners typically utilized in laundry detergents include derivatives of diarylethene (stilbene), such as derivatives which include diene and/or azo based chromophor groups. In certain embodiments, the cleaning composition includes less than 5, 1. 0.5, or 0.1, wt. % of the optical brighteners typically utilized in laundry detergents. In other embodiments, the cleaning composition is free of the optical brighteners typically utilized in laundry detergents.

Laundry detergents, as are understood in the art, also typically include redeposition polymers. Non-limiting examples of redeposition polymers typically utilized in laundry detergents include polyvinyl pyrrolidone (PVP), carboxymethylcellulose (CMC), homopolymers of acrylic acid (P-AA), copolymers of acrylic/maleic acid (P-AA/MA), or combinations thereof. In certain embodiments, the cleaning composition includes less than 5, 1. 0.5, or 0.1, wt. % of the redeposition polymers typically utilized in laundry detergents. In other embodiments, the cleaning composition is free of the redeposition polymers typically utilized in laundry detergents.

### Method of Forming the Cleaning Composition

A method of forming the cleaning composition is also disclosed. The method includes the step of combining the alkoxylated polyethylenimine and the surfactant actives component to form the cleaning composition. The step of combining the alkoxylated polyethylenimine and the surfactant actives component may be further defined as the step of combining the alkoxylated polyethylenimine, the surfactant actives component, and water to form the cleaning composition. The surfactants of the surfactant actives component can be combined in any order with the alkoxylated polyethylenimine, the other surfactants of the surfactant actives components, and/or the water. The alkoxylated polyethylenimine, the surfactant actives component, and water can be utilized in the amounts described above. As one example, the anionic surfactant may be first combined with the betaine and then the alkoxylated polyethylenimine may be combined with the anionic surfactant and the betaine. As another example, the alkoxylated polyethylenimine may be first combined with the betaine and then the anionic surfactant may be combined with the alkoxylated polyethylenimine and the betaine. As yet another example, water may be first combined with the anionic surfactant to form a first solution. Next, the betaine may be combined with the first solution to form a second solution. Next, the alkoxylated polyethylenimine may be combined with the second solution to form the cleaning composition.

In embodiments including lactic acid, the method includes the step of combining the alkoxylated polyethylenimine, the lactic acid, and the surfactant actives component to form the cleaning composition. The step of combining the alkoxylated polyethylenimine, the lactic acid, and the surfactant actives component may be further defined as the step of combining the alkoxylated polyethylenimine, the lactic acid, the surfactant actives component, and water to form the cleaning composition. The surfactants of the surfactant actives component can be combined in any order with the alkoxylated polyethylenimine, the lactic acid, the other surfactants of the surfactant actives components, and/or the water. The alkoxylated polyethylenimine, the surfactant actives component, and water can be utilized in the amounts described above.

In other embodiments including lactic acid, the method includes the step of combining the alkoxylated polyethylenimine and the surfactant actives component to form a third solution. The step of combining the alkoxylated polyethylenimine and the surfactant actives component may be further defined as the step of combining the alkoxylated polyethylenimine, the surfactant actives component, and water to form the third solution. The surfactants of the surfactant actives component can be combined in any order with the alkoxylated polyethylenimine, the other surfactants of the surfactant actives components, and/or the water. The alkoxylated polyethylenimine, the surfactant actives component, and water can be utilized in the amounts described above.

In these other embodiments including lactic acid, the method further include the step of combining the supplemental acid different from the lactic acid with the third solution to form a fourth solution. The fourth solution typically has a pH of no greater than 5. The supplemental acid, e.g. sulfuric acid, is generally utilized in an amount that lowers the pH of the fourth solution to no greater than 5 from an initial pH which is generally greater than 5, e.g. a pH of ˜7+. This is useful for improved economics, in instances where the supplemental acid may be less costly than the lactic acid. In various embodiments, only the lactic acid (rather than the supplemental acid) is utilized in an amount sufficient to obtain the desired level of pH for the cleaning composition, e.g. a pH of 3.

In these other embodiments including lactic acid, the method yet further includes the step of combining the lactic acid and the fourth solution to form the cleaning composition. The lactic acid is typically utilized in an amount sufficient to obtain the desired level of pH for the cleaning composition, e.g. a pH of 3. In this way, the desired level of pH for the cleaning composition can be obtained.

In certain embodiments, each component of the cleaning composition (e.g, the alkoxylated polyethylenimine, the lactic acid, each surfactant of the surfactant actives component, etc.) is combined with water one at a time. The method may further include one of more steps. Such steps can include the addition of one or more of the supplemental components described above. Such components can be added at various times during formation of the cleaning composition. The cleaning composition can be formed utilizing conventional mixing equipment understood in the art.

### EXAMPLES

Comparative compositions (referred to as “comparative” below) and cleaning compositions representative of this disclosure (referred to as “example” below) are prepared and evaluated.

In Table I below, comparative compositions include an alcohol and are free of the alkoxylated polyethylenimine of this disclosure. The cleaning compositions are formed by combining the various components illustrated in Table I below. After formation, the cleaning compositions in Table I are evaluated for viscosity reduction. Viscosity of the cleaning compositions is determined utilizing a Brookfield LV viscometer, spindle #2 (or #62), at 12 RPM, at 23° C.

In Table II below, comparative compositions are free of alkoxylated polyethylenimine of this disclosure. The cleaning compositions are formed by combining the various components illustrated in Table II below. After formation, the cleaning compositions in Table II are evaluated for cleaning performance. Cleaning performance of the cleaning compositions is determined according to ASTM D4009, Method A, Lard Soil. Lard Soil is 100% pork fat based lard.

In Table III below, the effectiveness of the antibacterial properties exhibited by a cleaning composition representative of this disclosure is determined according to EN 1276, Quantitative Suspension of Bactericidal Activity of Chemical Disinfectants. For the cleaning composition to be considered “effective” under EN 1276, the cleaning composition must provide at least a 5 log reduction of bacteria in no greater than 5 minutes.

In Tables I, II, and III below, wt. % of surfactant actives (% act.) is provided for each of the compositions.

TABLE I

| | Comparative 1 | | Comparative 2 | | Example 1 | | Example 2 | |
|---|---|---|---|---|---|---|---|---|
| Component | wt. % | % act. | wt. % | % act. | wt. % | % act. | wt. % | % act. |
| Anionic Surfactant 1 | 46.45 | 13.93 | 34.80 | 10.44 | 46.45 | 13.93 | 34.80 | 10.44 |
| Nonionic Surfactant 1 | 13.48 | 6.74 | 20.20 | 10.10 | 13.48 | 6.74 | 20.20 | 10.10 |
| Betaine Surfactant 1 | 5.00 | 1.85 | 5.00 | 1.85 | 5.00 | 1.85 | 5.00 | 1.85 |
| Alkoxylated PEI | — | — | — | — | 0.50 | — | 0.50 | — |
| Alcohol 1 | 1.50 | — | 4.00 | — | — | — | — | — |
| Lactic Acid | — | — | 2.84 | — | — | — | 2.84 | — |
| Supplemental Acid 1 | 0.32 | — | 1.65 | — | 0.32 | — | 1.65 | — |
| Salt 1 | — | — | — | — | 1.50 | — | — | — |
| Diluent 1 | 33.25 | — | 31.51 | — | 32.75 | — | 35.01 | — |
| Total | 100 | 22.52 | 100 | 22.39 | 100 | 22.52 | 100 | 22.39 |

| Property | Comparative 1 | Comparative 2 | Example 1 | Example 2 |
|---|---|---|---|---|
| Viscosity (cps) | 1,450 | 1,235 | 600 | 560 |

The cleaning compositions of Example 1 and Example 2 each have a reduced viscosity which is attributable to the inclusion of alkoxylated PEI as compared to the cleaning compositions of Comparative 1 and Comparative 2 which are free of the alkoxylated PEI and include alcohol 1. Low levels of the alkoxylated PEI compared to higher levels of the alcohol 1 can reduce the viscosity of various surfactant solutions (e.g., cleaning compositions). Further, the alkoxylated PEI can be 4 to 8 times more effective than the alcohol 1 in reducing the viscosity of various surfactant solutions (e.g., cleaning compositions). Also the alkoxylated PEI is typically non-volatile, not characterized as a volatile organic compound (VOC), and non-flammable.

TABLE II

| | Comparative 3 | | Comparative 4 | | Example 3 | | Example 4 | |
|---|---|---|---|---|---|---|---|---|
| Component | wt. % | % act. | wt. % | % act. | wt. % | % act. | wt. % | % act. |
| Anionic Surfactant 2 | 22.00 | 15.40 | 22.00 | 15.40 | 22.00 | 15.40 | 22.00 | 15.40 |
| Nonionic Surfactant 1 | 4.00 | 2.00 | 4.00 | 2.00 | 4.00 | 2.00 | 4.00 | 2.00 |
| Nonionic Surfactant 2 | 4.50 | 4.50 | 4.50 | 4.50 | 4.50 | 4.50 | 4.50 | 4.50 |
| Betaine Surfactant 1 | 17.80 | 6.59 | — | — | 17.80 | 6.59 | — | — |
| Amine Oxide 1 | — | — | 23.30 | 6.99 | — | — | 23.30 | 6.99 |
| Alkoxylated PEI | — | — | — | — | 0.34 | — | 0.34 | — |
| Alcohol 1 | 5.00 | — | 5.00 | — | 5.00 | — | 5.00 | — |
| Diluent 1 | 46.70 | — | 41.20 | — | 46.36 | — | 40.86 | — |
| Total | 100 | 28.49 | 100 | 28.89 | 100 | 28.76 | 100 | 28.89 |

| Property | Comparative 3 | Comparative 4 | Example 3 | Example 4 |
|---|---|---|---|---|
| Plate Test, Lard Soil | 22 | 24 | 24 | 28 |

The cleaning composition of Example 3 as compared to the cleaning composition of Comparative 3 has superior cleaning performance which is attributable to the inclusion of alkoxylated PEI. The cleaning composition of Example 4 as compared to the cleaning composition of Comparative 4 has superior cleaning performance which is also attributable to the inclusion of alkoxylated PEI.

TABLE III

| | Example 5 | | Reduction of Bacteria According to EN 1276 | | | |
|---|---|---|---|---|---|---|
| Components | wt. % | % act. | E. coli | P. aeruginosa | S. aureus | E. hirae |
| Anionic Surfactant 1 | 40.00 | 11.60 | ≥6.2 | ≥5.7 | ≥7.1 | ≥6.5 |
| Anionic Surfactant 3 | 3.50 | 1.40 | | | | |
| Nonionic Surfactant 1 | 23.20 | 11.60 | | | | |
| Betaine Surfactant 1 | 4.85 | 1.79 | | | | |
| Alcohol 1 | 2.00 | — | | | | |
| Lactic Acid | 2.84 | — | | | | |
| Supplemental Acid 1 | 2.00 | — | | | | |
| Diluent 1 | 21.61 | — | | | | |
| Total | 100.00 | 26.39 | | | | |

The cleaning composition of Example 5 including lactic acid provides at least a 5 log reduction of the bacteria in no greater than 5 minutes for E. coli, P. aeruginosa, S. aureus, and E. hirae. Therefore, the cleaning composition is considered “effective” under EN 1276 against E. coli, P. aeruginosa, S. aureus, and E. hirae.

Anionic Surfactant 1 is an anionic surfactant including a mixture of sodium alkyl sulfates, mainly the lauryl, i.e., SLS (C10-C16) and is commercially available from BASF Corporation.

Anionic Surfactant 2 is an anionic surfactant including sodium lauryl ether sulphate with 2 moles of ethylene oxide and is commercially available from BASF Corporation.

Anionic Surfactant 3 is an anionic surfactant including sodium-n-octyl sulphate and is commercially available from BASF Corporation.

Nonionic Surfactant 1 is a nonionic surfactant, and specifically, a lauryl/myristyl glucoside consisting of C12, 14, 16 alkyl polyglycoside, and commercially available from BASF Corporation. This surfactant is un-preserved, i.e., it does not include a preservative. As such, this surfactant is generally alkaline having a pH of from 11.5 to 12.5.

Nonionic Surfactant 1 is a nonionic surfactant, and specifically, an alkyl polyethylene glycol ether based on C10-Guerbet alcohol and ethylene oxide, commercially available from BASF Corporation.

Betaine Surfactant 1 is an amphoteric surfactant and, specifically, a cocoamido propyl betaine, commercially available from BASF Corporation.

Amine Oxide 1 is a lauramine oxide, commercially available from BASF Corporation.

Alkoxylated PEI is an aqueous solution of 80 wt. % cleaning polymer and, specifically, a branched ethoxylated polyethylenimine having 20 ethoxy moieties bonded to each nitrogen atom and a polyethylenimine backbone having a weight average molecular weight of 600 g/mol, commercially available from BASF Corporation. This branched ethoxylated polyethylenimine has a weight average molecular weight of 11,000 g/mol.

Alcohol 1 is monohydric alcohol and, specifically, ethanol.

Lactic Acid (80%) is an aqueous solution of 80 wt. % lactic acid and is commercially available from Purac.

Supplemental Acid 1 is an aqueous solution of 30 wt. % sulfuric acid.

Salt 1 is sodium chloride (NaCl).

Diluent 1 is (DI) water.

One or more of the values described above may vary by −5%, −10%, −15%, −20%, −25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1. A cleaning composition for dishwashing, said cleaning composition comprising:
an alkoxylated polyethylenimine in an amount of from 0.01 to 20 wt. %; and
a surfactant actives component comprising;
an anionic surfactant in an amount of from 1 to 99 wt. %,
an additional surfactant in an amount of from 0 to 99 wt. %,
a betaine in an amount of from 0.1 to 7 wt. %, and
an amine oxide in an amount of from 0 to 6 wt. %;
with the proviso that the total wt. % of said anionic surfactant, said additional surfactant, said betaine, and said amine oxide is in an amount of at least 20 wt. %; and
wherein each wt. % is based on a total weight of said cleaning composition.

2. The cleaning composition of claim 1 which is free of an amine oxide.

3. The cleaning composition of claim 1 which is free of an alcohol.

4. The cleaning composition of claim 1 wherein said alkoxylated polyethylenimine is ethoxylated.

5. The cleaning composition of claim 1 wherein said alkoxylated polyethylenimine has a weight average molecular weight of from 5,000 to 20,000 g/mol.

6. The cleaning composition of claim 1 wherein said alkoxylated polyethylenimine has a plurality of nitrogen atoms and has from 1 to 40 ethoxy moieties bonded to each nitrogen atom.

7. The cleaning composition of claim 1 wherein said alkoxylated polyethylenimine is present in an amount of from 0.1 to 5 wt. % based on a total weight of said cleaning composition.

8. The cleaning composition of claim 1 wherein said anionic surfactant is chosen from a sodium lauryl sulfate (SLS), a sodium lauryl ether sulfate (SLES), a linear alkylbenzene sulfonate (LAS), or combinations thereof.

9. The cleaning composition of claim 1 wherein said anionic surfactant is present in an amount of from 5 to 20 wt. % based on a total weight of said cleaning composition.

10. The cleaning composition of claim 1 wherein said betaine is present in an amount of from 1 to 3 wt. % based on a total weight of said cleaning composition.

11. The cleaning composition of claim 1 wherein said additional surfactant comprises a nonionic surfactant.

12. The cleaning composition of claim 11 wherein said nonionic surfactant is an alkyl polyglycoside (APG).

13. The cleaning composition of claim 11 wherein said nonionic surfactant is present in an amount of from 1 to 20 wt. % based on a total weight of said cleaning composition.

14. The cleaning composition of claim 1 further comprising water in an amount of from 1 to 80 wt. % based on a total weight of said cleaning composition.

15. The cleaning composition of claim 1 having a viscosity of from 100 to 1200 millipascal-second (mPa·s) at 23° C.

16. The cleaning composition of claim 1 further comprising lactic acid.

17. The cleaning composition of claim 16 wherein said lactic acid is present in an amount of from 0.1 to 20 wt. % based on a total weight of said cleaning composition.

18. The cleaning composition of claim 1 having a pH of no greater than 4.

19. A cleaning composition for dishwashing, said cleaning composition comprising:
an alkoxylated polyethylenimine in an amount of from 0.1 to 5 wt. %; and
a surfactant actives component consisting essentially of;
an anionic surfactant in an amount of from 5 to 20 wt. %,
a betaine in an amount of from 0.1 to 7 wt. %, and
a nonionic surfactant in an amount of from 1 to 20 wt. %;
with the proviso that the total wt. % of said anionic surfactant, said betaine, and said nonionic surfactant is in an amount of at least 20 wt. %; and
wherein said cleaning composition is free of an alcohol;
wherein said cleaning composition is free of an amine oxide; and
wherein each wt. % is based on a total weight of said cleaning composition.

20. A method of forming a cleaning composition for dishwashing, said method comprising the step of:
combining an alkoxylated polyethylenimine and a surfactant actives component to form the cleaning composition;
wherein the cleaning composition comprises the alkoxylated polyethylenimine in an amount of from 0.01 to 20 wt. % and the surfactant actives component comprising;
an anionic surfactant in an amount of from 1 to 99 wt. %,
an additional surfactant in an amount of from 0 to 99 wt. %,
a betaine, in an amount of from 0.1 to 7 wt. %, and
an amine oxide in an amount of from 0 to 6 wt. %;
with the proviso that the total wt. % of the anionic surfactant, the additional surfactant, the betaine, and the amine oxide is in an amount of at least 20 wt. %; and
wherein each wt. % is based on a total weight of the cleaning composition.
